(19) United States
(12) Patent Application Publication
(10) Pub. No.: US 2013/0193957 A1
(43) Pub. Date: Aug. 1, 2013

(54) RESOLVER

(71) Applicant: Dawei Zhou, Andover (GB)

(72) Inventor: Dawei Zhou, Andover (GB)

(73) Assignee: AMETEK AIRTECHNOLOGY GROUP LIMITED, Leicester (GB)

(21) Appl. No.: 13/805,945

(22) PCT Filed: Jun. 22, 2011
(86) PCT No.: PCT/GB2011/051173

§ 371 Date: Apr. 10, 2013

(30) Foreign Application Priority Data
Jun. 22, 2010 (GB) 1010450.3

(51) Int. Cl. G01B 7/30

(52) U.S. Cl. CPC G01B 7/30
USPC 324/207.16

(57) ABSTRACT

A brushless axial flux electromagnetic resolver comprising a stator carrying output and excitation windings and an inductive rotor having two substantially annular members arranged substantially perpendicular to the axis of rotation of the rotor, wherein each of the annular members has a lobe which is helically skewed along the rotor and wherein the lobes of the annular members are angularly offset from one another to provide a discontinuity in the helical skew between the annular members.

### FIELD OF THE INVENTION

This invention relates to brushless resolvers for measuring the relative angular position and/or angular speed of mutually rotating components, such as a rotor and stator. More particularly this invention relates to a rotor structure for a brushless axial flux variable reluctance resolver.

### BACKGROUND OF THE INVENTION

Electromagnetic resolvers are used to indicate the angular position and consequently the angular speed of mutually rotatable components. In general this indication is provided by a rotor and stator carrying electromagnetic windings configured such that the degree of inductive coupling between the rotor and stator windings is a function of their relative angular position.

Brushless electromagnetic resolvers have been proposed. A brushless resolver generally includes two sets of windings, arranged on two mutually rotatable inductive/magnetic components, coupled to (or forming a part of) a rotor and a stator respectively. The first set of windings functions as a rotary transformer to inductively couple an AC voltage from a transformer winding on the stator to a corresponding transformer winding (excitation winding) on the rotor without the need for brushes or slip rings. The excitation winding on the rotor is electrically connected to a rotor output winding which, in turn, inductively couples with a corresponding output winding on the stator. The output windings are arranged on the rotor and stator so that the strength of inductive coupling between the output windings provides an indication of the angular position of the rotor. Generally the stator output winding include a pair of windings arranged in space quadrature (e.g. at 90° to each other). Thus, while the total flux through rotor and stator remains constant, the output windings on the rotor and the stator can be arranged so that the amplitude of the AC voltage induced in the quadrature stator output windings is dependent on the relative angular position of rotor and stator.

Brushless electromagnetic variable reluctance resolvers have also been proposed in which the rotor carries no electrical windings. In such resolvers the excitation and output windings can both be arranged on the stator and there is no requirement for a rotary transformer to couple electric current to the rotor because the rotor acts only as a variable reluctance rotating transformer core which inductively couples an excitation winding preferentially with one of a number of output windings dependent on its orientation.

U.S. Pat. No. 6,518,752 and European patent EP0174290 describe axial flux variable reluctance resolvers in which an inductive (i.e. highly magnetically permeable, |μᵣ|>>1) rotor ring is aligned at an oblique angle to the axis of rotation of the rotor.

Axial flux variable reluctance resolvers employ excitation windings between two sets, or stacks, of stator pieces. The stator stacks generally comprise pieces of a highly permeable material arranged in an annular configuration about the centre line of the resolver (axis of rotation of the rotor) the stator stacks being axially spaced apart from each other along the axis of rotation of the resolver rotor. In this “axial flux” configuration, each of the two stator stacks cooperates with a single polarity rotor pole piece, i.e. flux always flows out of one stator stack through the rotor and into the other stator stack (in the case of DC current in the excitation windings).

It has been proposed to “magnetically connect” the outer radial extremity of the stator stacks using a magnetic housing, for example a cylindrical sleeve of highly permeable material. Alternatively, a magnetic bridge ring can be put between two stator stacks to conduct flux from one stator stack to the other one. When electric current is passed through excitation coils between two stator stacks, the magnetic flux induced by the excitation current flows axially through the ring bridge or housing (outer sleeve), radially inward through the first of the stator stacks, axially within the resolver (preferentially through the rotor) and radially outward through the second of the stator stacks back to the sleeve. In other words, the reason for using an oblique magnetic ring in an axial flux resolver is that it provides a flux path from one stator stack along the oblique magnetic ring in the direction of the axis of rotation and across the rotor to the other stator stack on the other side of the rotor.

The manufacture of a rotor comprising a substantially planar element mounted at an oblique angle on an axle presents certain difficulties. For example, once the rotor has been machined the span and pitch of the rotor cannot easily be adjusted. In addition, in operation, any “wobble” or free play of the rotor away from the axis of rotation causes errors in the angle measured by the resolver because the associated output signal changes are not distinguishable from rotations in the plane of interest. Thus there exists a need in the art for a resolver rotor having adjustable span and pitch and which can be more easily manufactured and preferably provides improved measurement accuracy.

### SUMMARY OF THE INVENTION

Aspects and examples of the invention are set out in the claims.

In an aspect there is provided an axial flux brushless electromagnetic resolver comprising: a stator carrying output and excitation windings; and an inductive rotor having a plurality of substantially annular inductive members arranged substantially perpendicular to the axis of rotation of the rotor, wherein the spatial distribution of inductive material of each annular member has a rotational symmetry of at least order one. As will be appreciated by the skilled practitioner in the context of the present disclosure, the accuracy of such a resolver depends sensitively upon the spatial distribution of inductive material in the rotor (amongst other factors). Examples of the invention have the advantage that the form (shape and pitch) of the rotor pole piece can be more easily designed to meet operational requirements and accurately milled/machined without the need for specialised machinery, unlike obliquely aligned rotor pole pieces.

Preferably the output windings comprise a first output winding and a second output winding arranged in space quadrature with the first output winding so that, where the induced electromotive force (e.m.f) in the first output winding depends on the sine of the angular position of the rotor the induced e.m.f in the second output winding depends on the cosine of the angular position of the rotor.

In an example the annular members are arranged such that the angular distribution of the inductive material in the rotor varies as a function of displacement along the axis of rotation of the rotor. This has the advantage of providing a resolver operable to provide angular measurements of further improved accuracy.

In one possibility the annular members are arranged such that the average angular position of inductive material in the rotor (the centre of mass of the highly permeable material) varies as a function of displacement along the axis of rotation of the rotor, preferably wherein the function of displacement along the axis of rotation of the rotor approximates a step or Heaviside function. Still more preferably the output windings are arranged such that output current/voltage signals from the windings comprise a signal which substantially corresponds to (e.g. is dominated by) the fundamental sinusoidal component of the trapezoid/square wave produced by cyclic repetition of this step/Heaviside function.

Preferably the function of the angular distribution of the inductive material in the rotor varies as a function of displacement along the axis of rotation of the rotor, preferably wherein the function of displacement along the axis of rotation of the rotor is selected to reduce discontinuities in the inductance as a function of displacement along the axis of rotation of the rotor. The inventors have observed that this has the advantage of improving accuracy by reducing the presence of harmonics of the fundamental sinusoidal component of the output signal.

In one possibility the annular members comprise a single piece.

In one possibility the annular members comprise inductive laminar sections adjacently stacked along the axis of rotation of the rotor (for example such that the major surfaces of the laminar sections are also substantially perpendicular to the axis of rotation of the rotor), This has the advantage of reducing eddy current losses and improving accuracy and has the further advantage simplifying and reducing the cost of manufacture of the annular members.

In a particularly preferable example the rotor comprises an inductive (highly permeable) hub upon which the laminar sections can be arranged.

Preferably an electrically insulating material is disposed between adjacent inductive laminar sections. Still more preferably adjacent inductive laminar sections are bonded by an electrically insulating material. In some examples the laminar sections comprise a plurality of inductive members arranged to minimise eddy currents within the laminar section due to inductive electromotive forces generated by rotation of the rotor in an axial magnetic field (i.e a magnetic field having a component parallel with the axis of rotation of the rotor). This has the advantage of reducing energy losses in the rotor.

Preferably the laminar sections are disposed such that the angular distribution of inductive material in at least one of the laminar sections is different from the angular distribution of inductive material in another one of the plurality of laminar sections. This has the advantage that using laminar sections having a low order of rotational symmetry, a rotor can be assembled which has a higher order of rotational symmetry thus providing a rotor for a twin-speed (or higher speed) resolver using simple components. This has the further advantage that by relatively rotating the single lobe laminar section on the rotor a multi-pole rotor pole-piece can be provided.

Preferably at least some of the plurality of laminar sections are mutually similar, optionally all of the plurality of laminar sections are mutually similar. Still more preferably at least one of the mutually similar laminar sections is angularly offset with respect to at least one other of the mutually similar laminar sections. These embodiments have the advantage of further simplifying the manufacture of the rotor components and reducing the cost of manufacture.

Preferably the annular members of the rotor comprise at least one lobe. In one possibility a lobe may be an arc of an annulus which subtends an angle at the centre of the annulus substantially equal to approximately 120°. This has the advantage of reducing particular harmonics in the output signal, such as the third harmonic of the tooth frequency. As will be appreciated by the skilled practitioner in the context of the present disclosure, the extent of the lobes may be adjusted to reduce other particular harmonics in the output signal depending on the number of lobes (teeth) on the rotor. In one possibility a lobe may be an arc of an annulus which subtends an angle at the centre of the annulus of at least 50°, preferably at least 60°, preferably at least 70°, preferably at least 80°, preferably at least 90°, preferably at least 100°, preferably at least 110°, preferably at least 115°. In one possibility a lobe may be an arc of an annulus which subtends an angle at the centre of the annulus of less than 140°, preferably less than 130°, preferably less than 125°.

Preferably the first output windings are arranged such that the self inductance of the first output windings varies as a first sinusoidal function of the azimuthal angle about the axis of rotation of the rotor, still more preferably the second output windings are arranged such that the self inductance of the second output windings varies as a second sinusoidal function of the azimuthal angle about the axis of rotation of the rotor. Preferably the first and second sinusoidal functions are substantially mutually orthogonal (e.g. from the electrical point of view).

Preferably the rotor comprises a balancing ring of non-inductive material. This has the advantage that the distribution of mass in the single-speed rotor can be balanced so that it behaves as a symmetrical top, i.e. preferably two of the principal moments of inertia of the rotor are the same and lie in the plane of rotation of the rotor preferably such that the principal axis of inertia of the rotor coincides with the axis of rotation of the rotor. In some possibilities the outer surface of the rotor comprises one or more lobes and preferably the balancing ring is shaped to fit around the lobes of the rotor. This has the advantage of providing a simple and robust construction and, because the sleeve comprises a material which is not highly permeable but highly electrically conductive, it provides a degree of electromagnetic shielding which weakens the armature reaction flux from the stator output windings.

In an aspect there is provided a rotor for a brushless electromagnetic resolver, wherein said resolver comprises a stator carrying output and excitation windings, the rotor comprising a plurality of substantially annular inductive members arranged substantially perpendicular to the axis of rotation of the rotor, wherein the inductance of each annular member has a rotational symmetry of at least order one.

As will be appreciated by the skilled practitioner in the context of the present disclosure the aspects and examples of the invention described herein are merely exemplary and do not limit the teaching of this disclosure. Accordingly, features described with reference to any example or aspect of the invention may be advantageously combined with one or more features of any other of the described examples and aspects of the invention.

In an embodiment inductive/highly permeable material comprises material of one or more types selected from the following list: diamagnetic, paramagnetic, ferromagnetic, anti-ferromagnetic, ferrimagnetic or anti-ferrimagnetic or a composite having some or all of the foregoing properties.

In an embodiment the present invention provides a brushless electromagnetic resolver substantially as herein described and/or as described with reference to the accompanying drawings. In an embodiment the present invention provides a rotor for a brushless electromagnetic resolver substantially as herein described and/or as described with reference to the accompanying drawings.

In one possibility there is provided an electromagnetic brushless axial flux resolver comprising:
a rotor comprising a rotor hub and first and second lobes, wherein the lobes and hub comprise a highly magnetically permeable material;
first and second stators disposed around the rotor wherein the first stator and second stator are spaced apart along the direction of the axis of rotation of the rotor;
an excitation winding on the stator arranged create a magnetic flux from the stator to the rotor when an electrical current passes through the excitation winding;
an output winding on the stator arranged to inductively couple with the excitation winding via the magnetic flux mediated through the rotor and the stator;
wherein the lobes are spaced apart on the rotor hub along the direction of the axis of rotation of the rotor, wherein the first and second lobes are angularly separated about the axis of rotation of the rotor so that the first and second lobes face angularly offset sections of the respective first and second stators, preferably wherein the first and second lobes are disposed at diametrically opposite positions on the rotor hub.

In one possibility a highly magnetically permeable housing or bridge ring links the two stator magnetically.

### SUMMARY OF DRAWINGS Embodiments of the invention will now be described in greater detail by way of example only with reference to the accompanying drawings, in which

FIG. 1 shows a very schematic view of a resolver;

FIG. 2 shows a schematic cross section of a resolver;

FIG. 3 shows a perspective view of a rotor pole piece for a resolver

FIG. 4 shows a cut away perspective view of the rotor of FIG. 3 mounted with a balancing ring;

FIG. 5 shows a perspective view of a helically skewed rotor pole piece for a resolver; and

FIG. 6 shows a cut away perspective view of the helically skewed rotor of FIG. 5 mounted with a balancing ring.

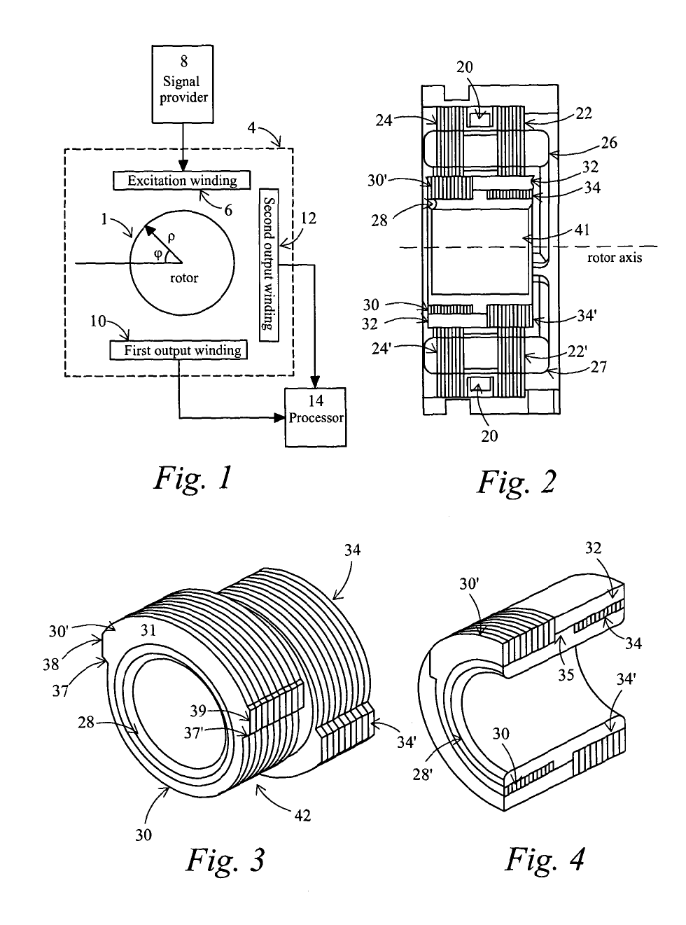

FIG. 1 shows a resolver including a rotor 1 and a stator 4. Stator 4 carries excitation windings 6, first output windings 10 and second output windings 12. Excitation windings 6 are electrically coupled to a signal provider 8 to receive an excitation signal 9 from the signal provider 8. The first and second output windings 10, 12 are arranged to couple inductively with an H-field generated by the excitation windings 6 and are electrically coupled to provide respective first and second output signals 16, 18 to a processor 14. Processor 14 comprises a signal output for providing an output signal to indicate the angular position and/or speed of the rotor with respect to the stator.

The rotor 1 is arranged to rotate in the stator and may be conveniently described using a cylindrical co-ordinate system i.e. in terms of a displacement along the axis of rotation of the rotor, z, an azimuthal angle φ, measured from a selected plane which contains the axis of rotation, and a radial extent, ρ, denoting a radial displacement from the axis of rotation.

The rotor 1 comprises an inductive material (for example a highly permeable material having a relative magnetic permeability μᵣ, not equal to that of free space) arranged such that the spatial distribution of inductive material of the rotor has a rotational symmetry of at least order one.

The rotor will be described in greater detail below with reference to FIGS. 2 to 6 but, generally, the high permeability material is selected to construct both the rotor pole piece and the hub in order to reduce the excitation current required to build up the magnetic field. The shape of the rotor is arranged such that the spatial distribution of the H-field generated by an electrical current in the excitation windings is dependent upon the relative angular position of the rotor and the stator.

As shown in FIG. 1, the first output winding 10 is arranged such that the mutual inductance of the first output windings and the excitation windings is proportional to the cosine of the angular position, ρ, of the rotor. Also in the example of FIG. 1, the second output winding 12 is arranged such that the mutual inductance of the second output windings and the excitation windings is proportional to the sine of the angular position, φ, of the rotor. Thus, in effect, the sensitivity profiles of the two output windings are orthogonal and so the angular position of the rotor can be resolved based on the relative magnitudes of the signals from respective ones of the first and second output windings. As used herein the term “sensitivity profile” is used to mean the mutual inductance between an output winding and the excitation winding as a function of the angle of rotation of the rotor with respect to the stator.

As will be appreciated by the skilled practitioner in the context of the present disclosure, this sinusoidal spatial dependence can be achieved (as described in greater detail with reference to FIGS. 2 to 6) by appropriate configuration of the rotor and by arranging the coils of the output windings to have an appropriate spatial distribution on the stator, for example a sinusoidal distribution winding or an equal pitch lap winding. Appropriate spatial distributions for these windings can be calculated using numerical methods familiar to the skilled practitioner, for example by reference to the desired sensitivity profile of the output windings and/or the desired H-Field produced by the excitation windings by an appropriate application of the Biot-Savart law, finite element analysis and other such methods.

FIG. 2 shows a very schematic drawing of a cross section of a resolver 40. The resolver of FIG. 2 comprises a rotor 41 which is rotatably mounted in first stator stack 22, 22′ and second stator stack 24, 24′ such that, as illustrated by a broken line in FIG. 2, the axis of rotation of the rotor lies in the plane of the diagram. The first and second stator stacks 22, 22′, 24, 24′ comprise an inductive material. The excitation coil 20 is placed between the first and second stator stacks 22, 22′, 24, 24′ and is electrically coupled to receive an AC signal from a signal provider, not shown in FIG. 2, such as signal provider 8 of FIG. 1.

Rotor 41 comprises a first annular member 30 of inductive material and a second annular member 34 of inductive material. Each annular member has an inner cylindrical surface and an outer surface and a radial thickness, i.e. the radial extent from its inner cylindrical surface to the outer surface of the annular member.

The annular members 30 34 are arranged to be substantially perpendicular to the axis of rotation of the rotor. Each annular member has first and second annular faces and an inner surface which is substantially right circular cylindrical. The annular members are arranged such that the centre line (longitudinal axis) of the cylinder defined by the inner surface of the annular member coincides with the axis of rotation of the rotor and so that the first and second annular faces are substantially perpendicular to this axis of rotation of the rotor. The annular members 30, 34 each comprise lobes of increased radial thickness so that the thickness of the annular members 30, 34 varies along their circumference. Thus the distribution of inductive material of each annular member has a rotational symmetry (about the axis of rotation of the rotor) of at least order one. The annular members of FIG. 2, 30, 34 both include a thicker region 30′ 34′ of greater radial thickness than the rest of the annular member. The annular members 30, 34 are arranged so that the thicker regions 30′, 34′ are not aligned and are displaced by 180° electrically on the rotor. As a result, along at least part of the circumference of the rotor the distribution of inductive material of the rotor varies as a function of displacement along the rotor axis.

The annular members 30 34 are carried on an inductive hub 28 and, as shown in cross section in FIG. 2 (and in perspective view in the examples of FIGS. 3 and 5). The provision of a highly permeable (inductive) hub for the rotor has the advantage that the resolver need not necessarily be provided with a highly permeable outer cover. To balance the distribution of mass in the rotor a balancing member 32, for example in the form of a ring or sleeve, is fitted to the rotor hub 41. The balancing ring 41 comprises a non-inductive material (for example a material having a relative permeability which is approximately equal to that of free space or which is substantially closer to unity than the material of the annular members 30, 34 and the rotor hub 28).

In FIG. 2, the rotor is in a particular angular position, (which for the purposes of this example shall be referred to as φ=0), so that the thicker region 30′ of the first annular member 30 is closer to the output windings 26 arranged on the first stator stack 24 than to the output windings 27 arranged between the opposite side of the stator stacks 22′, 24′ and the thicker region 30′ of the second annular member 30 is closer to the output windings 26. As will be understood by the skilled addressee, by making appropriate modifications to these arrangements the described embodiments can be generalized to any type (speed) of resolver. For examplen a single speed resolver the electrical phase is equivalent to the mechanical phase of rotation but for a 2-speed resolver, which has two electrical cycles per mechanical revolution, “opposite side” means 90 electrical degree offset

Thus the highly permeable material of the rotor pole piece provides a preferential path for flux from the region of the output windings 26 to the output windings 26. Thus, as can be seen qualitatively from this example as the angle, φ, of the rotor 41 is changed the flux linkage of regions of the stator output windings 26, 27 also changes. If the rotor is inverted (i.e. the case where φ=π, or 180°) the distribution of inductive material adjacent to each area of the windings and each stator stack, and hence the preferential flux path through the rotor will be opposite to that illustrated in FIG. 2 and so the inductive coupling between the excitation and output windings will change accordingly. The output windings 26, 27 are arranged in such a way that each output winding will pick up the fundamental component of the flat top trapezoidal function represented by the air gap between rotor and stator along with certain harmonics of this fundamental frequency.

The output windings 26 are also arranged such that the amplitude of the voltage induced in the first output windings 26 by an alternating current in the excitation windings 20 is a maximum with the rotor in a position φ=0° or φ=180° and a minimum with the rotor in a position φ=90° or φ=270°. Then, the second output windings 27 are arranged such that the amplitude of the voltage induced in the second output windings 27 by an alternating current in the excitation windings 20 is a maximum with the rotor in a position φ=90° or φ=270° and a minimum with the rotor in a position φ=0° or φ=180°. In other words, the sensitivity profiles of the excitation windings 26, 27 are arranged in space quadrature, i.e. at 90° to each other. This enables the angular position of the rotor to be derived from the relative amplitudes of the voltages induced in the output windings 26 and 27 respectively by an alternating current in the excitation windings.

In operation a signal provider (8 in FIG. 1) applies an AC voltage to excitation winding 20 and the signal induced in the output windings 26, 27 then depends on the relative angular position of rotor and stator. As the rotor rotates the output from each output winding 26, 27 approximates the sine and cosine respectively of the angular position of the rotor. This provides an indication of the angular position of the rotor.

FIG. 3 shows a perspective view of an example rotor pole piece comprising a permeable hub 28 and first and second annular members 30, 34 fitted to the hub 28. As shown in FIG. 3 these rotor pole pieces may each comprise a plurality of substantially similar laminar sections 42. Each laminar section has a first major surface 31 and a second major surface (not visible in FIG. 3). Also as shown in FIG. 3 these laminar sections 42 may be substantially similar and may have first and second major surfaces which correspond to the cross section of the annular faces of the annular members 30, 34. The laminar sections 42 are aligned such that their first and second major surfaces 31 are perpendicular to the axis of rotation of the rotor. Assembling the rotor pole piece from a plurality of substantially similar sections aligned perpendicular to the axis of rotation of a central hub has the advantage that relatively complex rotor geometries can be accurately provided from arrangements of a set of components which can be cheaply and accurately produced in large numbers. A further advantage is that fine tuning/adjustment of the rotor geometry e.g. span and pitch of the rotor can be easily provided by adjustments to the azimuthal angular alignment (angle of rotation about the axis of rotation of the rotor) of one or more of the laminar sections of the rotor and/or the axial, z, distribution of the laminar sections. Still more advantageously, a variation in the angular distribution of inductive material of the rotor can be provided without the need to use an obliquely aligned rotor.

The use of an inductive hub enables the rotor pole pieces to be axially spaced from each other along the hub without interrupting the preferential axial path for flux through the rotor between the stator stacks.

As shown in FIG. 3 the annular members 30 and 34 each carry a lobe, 30′ and 34′ respectively. The cross section of this lobe is substantially arch shaped and bounded at each lobe end 38, 39 by substantially straight, substantially parallel edges. The corners 37, 37′ of these edges may be beveled as shown to provide a lip between the surface of the annular member and the lobe end. In other possibilities the specific shaped edge of pole piece (lobe) is selected so that the end-shape or the corner shape of the lobe is tapered in order to reduce the tooth-order harmonics. The inventors in the present case have found that these harmonics can not be eliminated by changing the winding design and have appreciated that it is possible to reduce the impact of this artifact on the purity of sinusoidal output waveform by selecting the shape/profile of the pole piece corners. Skewing the rotor pole piece has also been found to reduce tooth-order harmonics.

In one possibility the lobe approximates a kidney shape i.e. the ends of the arch are convex rather than parallel.

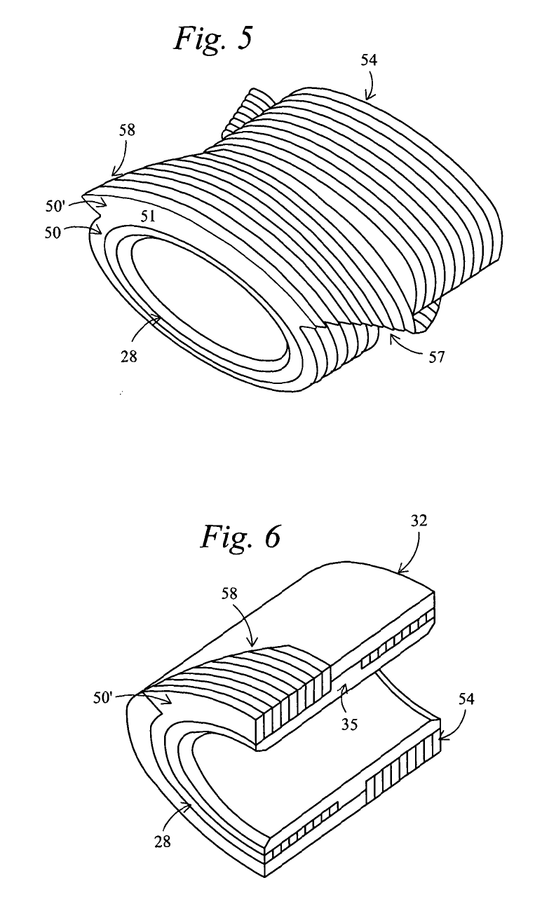

FIG. 4 shows a perspective cut away view of the rotor of FIG. 3 mounted with a balancing member 32. As described above with reference to FIGS. 2 and 3, the rotor pole piece comprises an inductive hub 28 carrying inductive annular members 30 and 34. In the example of FIG. 4 the hub 28 comprises a circumferential ridge 35 which axially spaces apart the annular members 30, 34 of the rotor on the hub. This ridge has the advantage of physically separating the annular members of the rotor so that the pitch angle between the lobes of the annular members 30, 34 can be accurately determined by simply machining (turning) a ridge of particular axial extent on the hub.

The distribution of mass of the rotor pole piece can be somewhat asymmetric therefore a balancing member 32, in the form of a ring or sleeve can be mounted to the pole piece so that the distribution of mass of the rotor is made more symmetrical. In general the balancing member comprises a non-inductive material, i.e a material having a low relative permeability, for example approximately unity, μᵣ˜1. The balance ring or sleeve is electrically conductive in order to produce eddy-current to weaken the impact of the armature reaction once the output windings carry current. The flux due to armature reaction can distort the main flux waveform produced by the excitation winding 20.

The rotor configuration of FIGS. 3 and 4 tends to provide an output signal which varies as a square (or trapezoid) wave function of the angular position of the rotor where the duty cycle of the square wave depends upon the angular extent of the rotor lobes. One example of a square wave is V₂₆∝sign[sin(φ)] whilst V₂₇∝sign[cos(φ)] where φ is the angular position of the rotor with respect to the stator and V₂₆ and V₂₇ represent the voltage induced in the first and second output windings respectively.

To provide a smooth sinusoidal variation of output voltage with rotor angle the output windings can, for example, be arranged on the stator stacks in an equal lap winding arrangement. For example, if the output windings 26, 27 are arranged in this manner and so that their respective sensitivity profiles are in space quadrature, when the rotor is disposed at some angle φ then the voltage in output winding 26, may be written as V₂₆∝cos(φ), and the voltage in output winding 27 may be written as, V₂₇∝sin(φ).

FIG. 5 shows a perspective view of a rotor pole piece having a highly permeable (inductive) hub 28 carrying first and second substantially annular members 50, 54 comprising a highly permeable (inductive) material. As described above with reference to FIGS. 3 and 4 the annular members have an inner cylindrical surface and two axial end faces each substantially perpendicular to any axial straight line on the inner cylindrical surface. The annular members are arranged on the rotor so that their axial end faces are substantially perpendicular to the axis of rotation of the rotor.

Annular members 50, 54 carry lobes 50′, 54′ which have across section generally corresponding to a sector of an annulus. The lobes 50′, 54′ are skewed across the outer surface of the rotor so that the angular position cp of the lobes varies along the axis of the rotor. In the example of FIG. 5 the skewed lobes 50′, 54′ follow a generally helical line along the surface of the respective annular member 50, 54. Each lobe is bounded by a first lobe end 57 and a second lobe end 58.

The annular members 50, 54 comprise a plurality of substantially laminar sections. Each laminar section has a first major surface 51 and a second major surface (not visible in FIG. 5) which correspond to the end face of the annular members 50, 54. In the example of FIG. 5 the shape of the first and second major surfaces resembles an inner annulus of a first radial extent bounded along an arc of its outer edge by a sector shaped lobe of a second radial extent. This provides a substantially laminar annulus of highly permeable (inductive) material having an in-plane rotational symmetry of at least order one. In the example of FIG. 5 the ‘arc’ lobe subtends an angle at the centre of the annulus of approximately 120° of “electrical phase” (i.e. the phase of the output signal produced by rotation). This has the advantage of reducing the 3^{rd} order tooth harmonic. The lobe span can be adjusted from 90 to 180 electrical degree to match the stator winding design.

The lobe corners are shaped to reduce tooth-order harmonic flux or may be skewed across the surface of the rotor reduce these harmonics. Either or both approaches can be used although the skew method is particularly advantageous since, to improve the concentricity, the outer diameter of the pole piece can be machined after pole pieces are assembled to the hub without fearing that the profile of pole piece be changed. Final machining process is not recommended for the profiled pole piece design, since the such a process may destroy the designed profile.

Although we think either profiled pole piece or skewed rotor is adequate to overcome the tooth-order harmonic. It does not mean that we can not employ both methods in one design

In FIG. 5 the laminar sections of the annular members are arranged so that the major surfaces of each laminar section are substantially parallel and so that the lobe of each laminar section is slightly rotated relative to its neighbour. The effect is to provide an annular member having a lobe which is skewed along the rotor, in other words the gradual rotation of the lobed laminar sections about the axis of the rotor means that the angular position of the lobe varies as a function of axial position along the rotor. This skewing of the rotor lobe provides a more gradual transition from the entire body of the lobe being adjacent to a particular area of output winding and an air gap being adjacent the windings as the rotor rotates in the stator. This has the advantage of reducing tooth order harmonics of the fundamental frequency of the square or trapezoid flux distribution which is picked up by the output windings. In other words, without a skewed rotor lobe, the expression given above for the voltage in the output windings 26 could be written as V₂₆∝cos(φ)+ΣAₙ.cos(nφ), where the summation is performed across the integer n. The presence of these tooth order harmonics can cause measurement errors in determining the rotor angle φ. By providing a skewed rotor lobe as shown in FIG. 5 the amplitudes Aₙ of these harmonics is reduced which has the advantage of reducing measurement errors.

The angle of rotation of each laminar section relative to its neighbor and the thickness of each laminar section determines the pitch or skew angle of the lobe on the rotor. Preferably the laminar sections are arranged such that the lobe is skewed at an angle which matches the rotor tooth pitch so that the skew angle is as shallow as possible to fit the required number of teeth on to the rotor.

FIG. 6 shows a perspective cut away view of the rotor of FIG. 5 mounted with a balancing member 32 as described above with reference to FIG. 4. The outline of the skew lobe edge 57 can be clearly seen.

As will be appreciated by the skilled reader in the context of the present disclosure, the term “inductive material” or “highly permeable material” includes, for example, any magnetically permeable material having a relative permeability different from that of free space (or, in some examples, substantially different to that of free space), for example such that the material is diamagnetic, paramagnetic, ferromagnetic, anti-ferromagnetic, ferrimagnetic or anti-ferrimagnetic or assembled from a composite having some or all of the foregoing properties.

1. A brushless axial flux electromagnetic resolver comprising:
a stator carrying output and excitation windings; and
an inductive rotor having two substantially annular members arranged substantially perpendicular to the axis of rotation of the rotor,
wherein each of the annular members has a lobe which is helically skewed along the rotor and wherein the lobes of the annular members are angularly offset from one another to provide a discontinuity in the helical skew between the annular members.

2. The resolver of claim 1, in which the lobe extends along an arc of the outer circumference of the annular member between first and second ends wherein the first and second ends extend axially along the rotor aligned in a substantially axial direction.

3. The resolver of claim 2, in which the transverse cross section of the lobe is arch shaped and bounded at the first and second ends by straight substantially parallel lines.

4. The resolver of claim 3, further comprising a feature of the lobe selected from the list consisting of:
the corners of the transverse cross section of the lobe being bevelled or rounded;
the lobe being skewed across the outer surface of the annular member;
the ends of the lobes being tapered to reduce discontinuities in the radial extent of the rotor;
the lobe extending along an arc of the outer circumference of the annular member between first and second lobe ends wherein the first and second lobe ends extend axially and circumferentially along the rotor; and
the lobe having first and second lobe ends extend axially and circumferentially along the rotor, which first and second ends follow a portion of a helical path along the outer circumference of the annular member.

5-7. (canceled)

8. The resolver of claim 4, in which the circumferential extent of the lobe is constant across its axial extent.

9. The resolver of claim 1, in which the plurality of annular members comprise first and second annular members and in which the lobe of the first annular member is angularly offset about the axis of rotation of the rotor with respect to the lobe of the second annular member.

10. The resolver of claim 9 in which the angular position of the lobe of the first annular member is diametrically opposite to the angular position of the lobe of the second annular member.

11. The resolver of claim 9, further comprising a feature of the annular members selected from the list consisting of:
the plurality of annular members comprising a third angular member, the lobe of the third annular member being angularly offset about the axis of rotation of the rotor with respect to the lobes of the first and second annular members;
the plurality of annular members comprising a third annular member and a fourth angular member, the lobe of the fourth annular member being angularly offset about the axis of rotation of the rotor with respect to the lobes of the first, second and third annular members; and
the lobes of the annular members being evenly spaced apart about the circumference of the rotor.

12-13. (canceled)

14. The resolver of claim 1, further comprising a feature of the stator selected from the list consisting of:
the stator comprising a plurality of stator stacks; and
the stator comprising one stator stack for each annular member of the rotor.

15. (canceled)

16. The resolver of claim 1, in which the output windings comprise a first output winding and a second output winding and in which the first and second output windings are arranged to reduce their mutual inductance.

17. The resolver of claim 1, in which the output windings comprise a first output winding and a second output winding, wherein the first and second output windings are substantially similar and arranged in space quadrature.

18. The resolver of claim 1, in which the output windings comprise a first output winding and a second output winding, in which the first output winding is arranged such that the induced electromotive force, e.m.f, in the winding depends on the sine of the angle of rotation of the rotor and the second output winding is arranged such that the induced e.m.f in the second output winding depends on the cosine of the angle of rotation of the rotor.

19. The resolver of claim 1, the annular members comprising inductive laminar sections, the laminar sections further comprising a feature selected from the list consisting of:
the laminar sections being adjacently stacked along the axis of rotation of the rotor such that the major surfaces of the laminar sections are substantially perpendicular to the axis of rotation of the rotor; and
at least some of the laminar sections being substantially mutually similar, preferably wherein all of the laminar sections are substantially mutually similar.

20. (canceled)

21. The resolver of claim 19 in which an electrically insulating material is disposed between adjacent inductive laminar sections.

22. The resolver of claim 19, in which the laminar sections are disposed such that the angular distribution of inductive material in at least one of the laminar sections is different from the angular distribution of inductive material in another one of the plurality of laminar sections.

23. The resolver of claim 1, in which the rotor comprises a sleeve of electrically conductive material configured to reduce armature reaction when the rotor is in use.

24. The resolver of claim 1, wherein the inductance of each annular member has a rotational symmetry of at least order one. 25-27. (canceled)

28. An electromagnetic brushless axial flux resolver comprising:
a rotor comprising a rotor hub and first and second lobes, wherein the lobes and hub comprise a highly magnetic permeable material;
first and second stators disposed around the rotor wherein the first stator and second stator are spaced apart along the direction of the axis of rotation of the rotor;
an excitation winding arranged create a magnetic flux from at least one of the first and second stators to the rotor when an electrical current passes through the excitation winding;
an output winding arranged on at least one of the first and second stators to inductively couple with the excitation winding via the magnetic flux mediated through the rotor and the stator;
wherein the lobes are spaced apart on the rotor hub along the direction of the axis of rotation of the rotor and the first and second lobes are angularly separated about the axis of rotation of the rotor so that the first and second lobes face angularly offset sections of the respective first and second stators.

29-30. (canceled)

31. A brushless axial flux electromagnetic resolver comprising: a stator carrying output and excitation windings; and an inductive rotor having a plurality of substantially annular inductive members arranged substantially perpendicular to the axis of rotation of the rotor, wherein the spatial distribution of inductive material of each annular member has a rotational symmetry of at least order one.

32. The resolver of claim 31 in which each of the annular members comprise a lobe of inductive material disposed along an arc of the outer circumference of the annular member.

33. (canceled)
